(19) United States
(12) Patent Application Publication
(10) Pub. No.: US 2008/0187677 A1
(43) Pub. Date: Aug. 7, 2008

(54) Ink compositions and methods for making the same

(76) Inventor: Alexey S. Kabalnov, San Diego, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/581,182

(22) Filed: Oct. 13, 2006

(51) Int. Cl. C08K 5/3415; B05D 1/00; B05D 5/00

(52) U.S. Cl. 427/466; 524/104; 427/256

(57) ABSTRACT

An ink composition includes a solvent system, an effective amount of at least one surfactant, an effective amount of at least one polymeric binder, water, and a pigment. The solvent system includes an effective amount of a betaine solvent and an effective amount of 2-pyrrolidone, glycerol, or a combination thereof.

### BACKGROUND

The present disclosure generally relates to ink compositions and methods for making the same.

Inkjet printing or recording systems are commonly used as an effective way of producing images on a print medium, such as paper. Generally, ink droplets are ejected from a nozzle at high speed by the inkjet recording system and onto the paper to produce an image thereon. The ink droplets are generally composed of a recording agent, such as a pigment, and a liquid vehicle, where the liquid vehicle generally includes water, one or more water-soluble organic solvents and other additives if desired.

It is generally advantageous to have an ink that will produce an image having desirable properties, including glossiness, low bronzing effect, rub resistance, and/or smear resistance. These image properties may generally be obtained using relatively high amounts of polymeric binders in the ink composition. The presence of such high amounts of polymeric binders, however, may in some instances generate problems with regard to poor decap time and/or nozzle clogging, both of which may deleteriously affect drop spreading of the ink on the print medium. A substantial concentration of organic solvent(s) may be used to dissolve the binders and to improve the overall print quality. However, some organic solvents or solvent systems tend to produce an undesirably pungent smell and may have undesirably high toxicity levels.

### DESCRIPTION OF THE DRAWING

Features and advantages of embodiment(s) of the present disclosure will become apparent by reference to the following detailed description and drawing.

FIG. 1 is a bar graph showing the decap time measurement (measured in seconds) of four embodiments of the ink composition disclosed herein, each having a different pigment, and of four comparison test samples.

### DETAILED DESCRIPTION

Embodiment(s) of the ink composition disclosed herein are pigmented inks, suitable for drop-on-demand inkjet printing, that may advantageously exhibit desirable decap time(s), higher resistance to rubbing and/or smearing, reduced nozzle clogging, and low odor and toxicity levels, while maintaining an effective amount of polymeric binders therein. The inks disclosed herein may also exhibit desirable levels of glossiness and low bronzing.

The term “decap,” as referred to herein, means the ability of the ink to readily eject from an ink printhead upon prolonged exposure to air. The ink decap time is measured as the amount of time that the ink printhead may be left uncapped before the printer nozzle no longer fires properly, potentially because of clogging or plugging. Generally, the nozzle may become clogged/plugged by a viscous plug that forms in the nozzle as a result of water loss, crusting of the ink, and/or crystallization of the pigment in and/or around any of the nozzles. If a nozzle has been plugged, ink droplets ejected through the nozzle's orifice may be misdirected, which may adversely affect print quality. The orifice may also become completely blocked and, as a result, the ink droplets may not pass through the affected nozzle.

The term “bronzing,” as used herein, refers to the phenomenon that a printed image has a metallic luster appearance rather than its intended color when viewed at an angle. Bronzing often manifests as a magenta sheen over cyan area fills, and a yellowish to reddish to bluish sheen over gray area fills. Generally, bronzing may be most severe at high gloss areas, and decreases at lower gloss areas.

The phrase “effective amount,” as used herein, refers to the minimal amount of a substance and/or agent, which is sufficient to achieve a desired and/or required effect. For example, an effective amount of an “ink vehicle” is the minimum amount required in order to create an ink composition, while maintaining properties suitable for effective inkjet printing.

Without being bound to any theory, it is believed that the combination of a betaine solvent and another organic solvent selected from glycerol and/or 2-pyrrolidone in the ink composition permits the ink composition to accommodate an effective amount of polymeric binders. It is further believed that the effective amount of polymeric binders in the ink composition improves image properties including desirable levels of glossiness, low bronzing and relatively high resistance to rubbing and/or smearing. It is also believed that the betaine and glycerol and/or 2-pyrrolidone solvent system allows the ink composition to exhibit more desirable decap times, less nozzle clogging, and lower odor and toxicity levels.

Embodiment(s) of the ink composition include an ink vehicle and a pigment. As used herein, the term “ink vehicle” refers to the combination of water and solvents (and additives, if desired) to form a vehicle in which a colorant is placed to form an ink composition. It is to be understood that the ink vehicle for embodiments of the ink composition as disclosed herein is suitable for pigmented inkjet ink compositions.

In an embodiment, the ink vehicle of the ink composition includes a betaine and glycerol solvent system, a betaine and 2-pyrrolidone solvent system, or a betaine, 2-pyrrolidone and glycerol solvent system, at least one surfactant, at least one polymeric binder, and water. Additives may also be incorporated in the ink vehicle. As used herein, the phrase “solvent system” refers to the combination of two or more organic solvents. An organic solvent is an organic or carbon-based compound that operates to dissolve a solute, thereby resulting in a solution. The solvent system is generally present in the ink vehicle in an amount ranging from about 10.0 to about 25.0 wt %. In a non-limiting example, the solvent system is present in the ink vehicle in an amount ranging from about 15 wt % to about 20 wt %.

The betaine constituent of the solvent system has a chemical structure represented by the formula (R₃)N⁺—CH₂—COO⁻, where R is CH₃. Without being bound to any theory, it is believed that because of its chemical structure, the betaine constituent of the solvent system acts as a solvent in the ink composition. This may be due, at least in part, to the fact that embodiment(s) of the betaine chemical structures disclosed herein generally do not have both a hydrophobic end and a hydrophilic end. Generally, betaine structures including both hydrophobic and hydrophilic ends act as surfactants, whereas the absence of one of such groups (i.e., both ends are hydrophilic or both ends are hydrophobic) is indicative of a solvent. Unlike betaine solvents, betaine surfactants generally have a low molecular solubility in water (i.e., critical micelle concentration). At any point above the critical micelle concentration, the betaine surfactant molecules tend to aggregate into micelles. Furthermore, betaine surfactants tend to adsorb at interfaces between the ink and the print medium, which may affect drop spreading on the print medium. Thus, image properties such as bleed control, dot gain and drying time may be deleteriously affected. The betaine solvent may be present in an amount ranging from about 5.0 to about 15.0 wt %. As a non-limiting example, the betaine solvent constitutes about 10.0 wt % of the total ink composition.

In an embodiment, the glycerol constituent of the solvent system is represented as a water-soluble organic solvent. The glycerol solvent may be present in an amount ranging from about 5.0 to about 15.0 wt %. In a non-limiting example, the glycerol solvent constitutes about 10.0 wt % of the total ink composition.

In another embodiment, the solvent system of the ink vehicle includes a betaine solvent and a 2-pyrrolidone solvent. Without being bound to any theory, it is believed that 2-pyrrolidone is a suitable substitute for glycerol to achieve the desired advantages of embodiment(s) of the ink composition as disclosed herein. The 2-pyrrolidone component of the solvent system is a water-soluble organic solvent that may be present in an amount ranging from about 5.0 to about 15.0 wt %. In a non-limiting example, the 2-pyrrolidone solvent constitutes about 10.0 wt % of the total ink composition.

In yet another embodiment, the solvent system of the ink vehicle may include a betaine solvent, glycerol and 2-pyrrolidone. As a non-limiting example, the glycerol constituent may be present in an amount ranging from about 3.0 to about 15.0 wt %, and the 2-pyrrolidone constituent may be present in an amount ranging from about 3.0 to about 15.0 wt % of the ink composition.

Still another embodiment of the ink composition may include diethylene glycol in addition to any of the betaine solvent systems disclosed herein. Generally, the diethylene glycol solvent is present in an amount ranging from about 0.0 wt % to about 10.0 wt %. In a non-limiting example, the diethylene glycol is present in an amount ranging from about 0.0 wt % to about 5 wt %.

Surfactants are included in the ink composition to assist in controlling the physical properties of the ink, such as jetting stability, waterproofness and bleeding. One or more surfactants may be used in the formulation of the ink. Some surfactant(s) (e.g., 1,2-diglycols or other non-ionic surfactants) may be present in larger amounts, for example, up to about 10.0 wt %. In an embodiment, the surfactant amount ranges from about 1.0 to about 10.0 wt %. Other surfactants may be included in the ink composition in smaller amounts, for example, from about 0.1 to about 0.3 wt %. In a non-limiting example embodiment, the ink includes about 0.2 wt % of surfactant(s).

The surfactant(s) used for embodiment(s) of the formulation of the ink is nonionic or anionic, and is generally a water-soluble organic ether or alcohol. Several commercially available nonionic surfactants may suitably be used in the formulation of the ink, examples of which include ethoxylated alcohols such as those from the Tergitol® series (e.g., Tergitol® 15S5, Tergitol® 15S7), manufactured by Union Carbide, located in Houston, Tex.; surfactants from the Surfynol® series (e.g. Surfynol® 440 and Surfynol® 465), manufactured by Air Products and Chemicals, Inc., located in Allentown, Pa.; fluorinated surfactants, such as those from the Zonyl® family (e.g., Zonyl® FSO and Zonyl® FSN surfactants), manufactured by E.I. duPont de Nemours Company, located in Wilmington, Del.; fluorinated PolyFox® nonionic surfactants (e.g., PG-154 nonionic surfactants), manufactured by Omnova, located in Fairlawn, Ohio; 2-diglycol surfactants, such as 1,2 hexanediol or 1,2-octanediol; or combinations thereof.

Suitable anionic surfactants that may be used in the ink composition include surfactants of the Dowfax® family (e.g., Dowfax® 8390), manufactured by Dow Chemical Company, located in Midland, Mich., or anionic Zonyl® surfactants (e.g., Zonyl® FSA), manufactured by E.I. duPont de Nemours Company; or combinations thereof.

Polymeric binders are particularly beneficial for stabilizing the ink composition for improved water and rub resistance, relatively good durability, relatively good gloss and low bronzing of the ink on the print media. The polymeric binder is generally water-soluble, and may be selected from those of the salts of styrene-(meth)acrylic acid copolymers, polyurethanes, other similar polymeric binders, or combinations thereof.

As a non-limiting example, one class of polymeric binders suitable for use in the ink include salts of styrene-(meth)acrylic acid copolymers. A salt of a styrene-(meth)acrylic acid copolymer includes at least a styrene skeleton and a skeleton of the salt of the styrene-(meth)acrylic acid copolymer in its structure. It may also contain a skeleton derived from a monomer having another unsaturated group, such as a (meth)acrylate skeleton, in its structure. Suitable non-limiting examples of styrene-(meth)acrylic acid copolymers are commercially available and may be selected from the Joncryl® series (e.g., Joncryl® 586 and 683), manufactured by BASF, Corp. located in Florham Park, N.J.; SMA-1000Na and SMA-1440K, manufactured by Sartomer, located in Exton, Pa.; Disperbyk 190, manufactured by BYK Chemicals, located in Wallingford, Conn.; polystyrene-acrylic polymers manufactured by Gifu Shellac, located in Japan; or combinations thereof. Polyurethanes may also be used as a suitable polymeric binder. Non-limiting examples of polyurethanes include those that are commercially available from Dainippon Ink & Chem, Inc. (DIC), located in Osaka, Japan.

Blends of the polymeric binders may also be used. Such polymeric binder combinations may be beneficial for improving rub resistance and gloss control (e.g., a blend of SMA 1000 Na and Joncryl® 683).

The polymeric binder concentration in an embodiment of the ink ranges from about 2.0 to about 6.0 wt %. In an embodiment, the polymeric binder is present in an amount ranging from about 2.0 to about 4.0 wt %. Percentages higher than 6.0%, however, will generally not be advantageous for the ink composition as nozzle clogging may arise due, at least in part, to over-thickening of the ink.

Additives may also be incorporated into embodiment(s) of the ink composition. As used herein, the term “additives” refers to constituents of the ink that operate to enhance performance, environmental effects, aesthetic effects, or other similar properties of the ink. Examples of additives include buffers, biocides, sequestering agents, chelating agents, or the like, or combinations thereof.

As a non-limiting example, bactericides, such as Proxel® GXL, may be added to the ink to protect the ink from bacterial growth. Another non-limiting example of an additive is a chelating agent, such as EDTA disodium salt, for improving kogation of the ink and/or the reliability of the ink by increasing the decap time. The additives, taken together, may be present in the ink in an amount of up to about 0.3 wt %. In an embodiment, the additives constitute about 0.2 wt % of the total ink concentration. In another embodiment, no additives are present in the ink.

The ink composition also includes water. Generally, the amount of water is present in an amount ranging from about 60.0 to about 80.0 wt %.

The ink vehicle is combined with a pigment to form the ink composition. As used herein, the term “pigment” refers to a colorant particle that is substantially insoluble in the liquid vehicle in which it is used. Suitable pigments include self-dispersed pigments and non-self-dispersed pigments. Self-dispersed pigments include those that have been chemically modified at the surface with a charge or a polymeric grouping. This chemical modification aids the pigment in becoming and/or substantially remaining dispersed in a liquid. A non-self-dispersed pigment utilizes a separate and unattached dispersing agent (e.g., polymers, oligomers, surfactants, etc.) in the liquid vehicle or physically coated on the surface of the pigment. The amount of pigment present in the ink composition ranges from about 1.0 to about 5.0 wt %.

Some non-limiting examples of suitable pigments for the ink include pigment cyan (PB) 15:3, pigment magenta (PR) 122, pigment yellow (PY) 155, PY 74, pigment red (PR) 168, pigment green (PG) 36, pigment violet (PV) 23, and carbon black (black) microencapsulated pigments. One method for preparing suitable pigment dispersions is described in Japanese Patent No. JP2003226831 A to Kaji et al., which is incorporated herein by reference in its entirety.

Examples of other suitable black pigments include Raven 7000, Raven 5750, Raven 5250, Raven 5000, and Raven 3500 (all of which are commercially available from Columbian Chemicals, Co. located in Marietta, Ga.). Other examples of suitable black pigments include Color Black FW 200, Color Black FW 2, Color Black FW 2V, Color Black FW 1, Color Black FW 18, Color Black S 160, Color Black S 170, Special Black 6, Special Black 5, Special Black 4A, Special Black 4 (all of which are commercially available from Degussa Corp. located in Parsippany, N.J.), and self-dispersed black pigments such as Cabo-Jet® 200 and Cabo-Jet® 300, manufactured by Cabot Corporation, located in Bellrica, Mass.

Examples of suitable classes of colored pigments include, but are not limited to anthraquinones, phthalocyanine blues, phthalocyanine greens, diazos, monoazos, pyranthrones, perylenes, heterocyclic yellows, quinacridones, and (thio)indigoids. Non-limiting examples of phthalocyanine blues include copper phthalocyanine blue and derivatives thereof (e.g., PB15). Examples of quinacridones include, but are not limited to pigment orange (PO) 48, PO49, PR122, PR192, PR202, PR206, PR207, PR209, pigment violet (PV) 19, PV42, or combinations thereof. Non-limiting examples of anthraquinones include PR43, PR194 (perinone red), PR216 (brominated pyrathrone red), PR226 (pyranthrone red), or combinations thereof. Perylene pigment examples include, but are not limited to PR123 (vermillion), PR149 (scarlet), PR179 (maroon), PR190 (red), PR189 (yellow shade red), PR224, or combinations thereof. Non-limiting examples of thioindigoids include PR86, PR87, PR88, PR181, PR198, PV36, PV38, or combinations thereof. Examples of suitable heterocyclic yellow pigments include, but are not limited to PY117, PY138, or combinations thereof. Examples of other suitable colored pigments are described in Colour Index, 3rd edition (The Society of Dyers and Colourists, 1982).

As a non-limiting example, the pigment selected for the ink may be a self-dispersible anionic pigment. A pigment precursor is chemically modified to impart water-dispersibility to the precursor. Such modifications include the incorporation of carboxylate and/or sulfonate functionalities. The anionic pigments may be associated with Na⁺, Li⁺, and NH₄⁺ cations, although other suitable counter-ions may be used herein.

Forming embodiment(s) of the ink composition includes providing or making the ink vehicle and adding an effective amount of pigment thereto. Without being bound to any theory, it is believed that the embodiment(s) of the ink disclosed above are pigmented inks. As such, embodiments of the ink composition generally do not include dyes.

In an embodiment of a method of using the embodiment(s) of the ink composition, the ink composition is established on at least a portion of the substrate to form an image. The amount of ink composition used depends, at least in part, on the desirable image to be formed. A non-limiting example of a suitable inkjet printing technique includes drop-on-demand inkjet printing, which encompasses thermal and piezoelectric inkjet printing. Suitable printers include portable drop-on-demand inkjet printers (e.g., handheld printers, arm mountable printers, wrist mountable printers, etc.), desktop drop-on-demand inkjet printers, or combinations thereof.

To further illustrate the embodiment(s) of the present disclosure, examples are given herein. It is to be understood that these examples are provided for illustrative purposes and are not to be construed as limiting the scope of the disclosed embodiment(s).

### EXAMPLE 1

Four inks were prepared according to an embodiment of the ink formulation disclosed herein. The ink vehicle (“Ink Vehicle A”) for these inks is depicted below in Table 1. The ink vehicle included a betaine/glycerol solvent system. Each ink included a different colored pigment selected from magenta, yellow, light cyan, and light magenta.

TABLE 1
Ink Vehicle A - Including a Betaine/Glycerol Solvent System

| COMPONENT | CONCENTRATION, wt % |
|---|---|
| 2-pyrrolidone | 2.0 |
| Glycerol | 10.0 |
| Betaine | 10.0 |
| Polymeric Binder (Joncryl ® 683) | 2.0 |
| Polymeric Binder (SMA-1000Na) | 0.175 |
| Nonionic surfactant | 0.2 |
| Biocide | 0.1 |
| Diethylene glycol | 1.0–4.0 |

Comparative test samples (“Example 1 CTS”) included those inks that came with the HP Photosmart Pro B9180 printer. Generally, the ink vehicle of the Example 1 CTS included various organic solvents (but not a betaine solvent), polymeric binders, and nonionic surfactants. Each of the Example 1 CTS inks included a different colored pigment selected from magenta, yellow, light cyan, and light magenta. The pigment loading for the Example 1 CTS inks was about the same as the pigment loading for the four inks prepared with Ink Vehicle A.

The decap times for the four inks and for the Example 1 CTS inks were tested using the HP Photosmart Pro B9180 printer. The decap times were measured (in seconds) using the printheads of the HP Photosmart Pro B9180 printer. The samples were tested in relatively similar testing conditions.

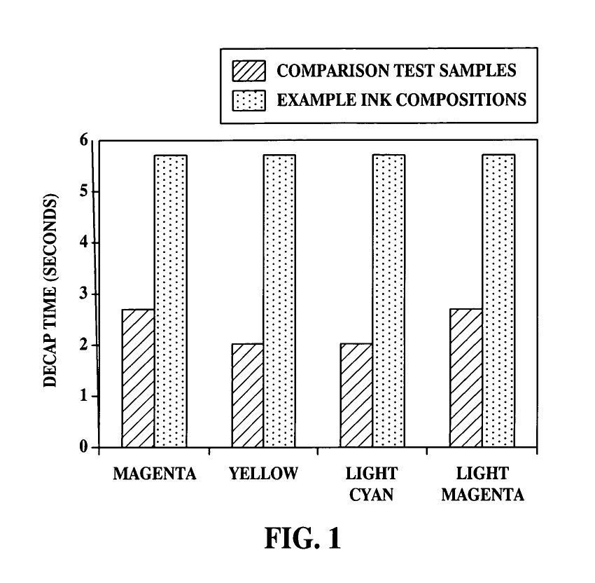

A bar graph of the decap time measurements of the four ink compositions (of this example) and the respective comparative test samples is shown in FIG. 1. The ‘bars’ labeled “comparative test samples” are the decap times measured for the Example 1 CTS inks having the pigments magenta, yellow, light cyan and light magenta, respectively. The ‘bars’ labeled “example ink compositions” are the decap times measured for the example ink compositions having the pigments magenta, yellow, light cyan and light magenta, respectively.

As shown in FIG. 1, the ink compositions including “Ink Vehicle A” provided substantial improvements in the decap time as compared to the ink of the Example 1 CTS for each pigment tested.

Higher concentrations of polymer binders in an ink formulation typically results in undesirably low decap times. The results shown in Table 2 (below) indicate that Ink Vehicle A, representing an embodiment of the present disclosure, combined with a pigment is useful for ink compositions having higher concentrations of polymeric binders.

TABLE 2
Binder Load for Example 1 Inks and Example 1
Comparative Test Samples

| | BINDER LOAD (wt %) | BINDER LOAD (wt %) |
|---|---|---|
| INK | EXAMPLE 1 CTS | “INK VEHICLE A” INKS |
| Magenta | <1.0 | 2.2 |
| Yellow | <1.0 | 2.2 |
| Light cyan | <2.0 | 2.2 |
| Light magenta | <2.0 | 2.2 |

### EXAMPLE 2

Two inks were prepared according to an embodiment of the ink formulation disclosed herein. The ink vehicle for these inks was “Ink Vehicle A” as described and shown in Table 1 of Example 1. One of the two inks was formulated with blue pigment and the other was formulated with red pigment.

Comparative test samples (“Example 2 CTS”) included those inks that came with the HP Designjet Z3100 printer. The ink vehicle of the Example 2 CTS inks included organic solvents (but not a betaine solvent), polymeric binders, and non-ionic surfactants. The printer contained twelve inks, including red and blue pigment-based inks. The pigment loading for the Example 2 CTS inks was about the same as the pigment loading for the red and blue inks prepared with Ink Vehicle A.

The decap times for the two inks and for the Example 2 CTS inks were tested using the HP Designjet Z3100 printer. The decap times were measured (in seconds) using the printheads of the HP Designjet Z3100 printer. The samples were tested in relatively similar testing conditions. The decap results are shown in Table 3.

TABLE 3
Decap times For Example 2 Inks and Example 2
Comparative Test Samples

| | DECAP TIME (SECONDS) | DECAP TIME (SECONDS) |
|---|---|---|
| INK | “INK VEHICLE A” INKS | EXAMPLE 2 CTS |
| Red | 6 | 3 |
| Blue | 7 | 3 |

The decap results of Table 3 illustrate a substantial improvement in decap for those ink formulated with an embodiment of the ink vehicle (e.g., betaine solvent and glycerol) disclosed herein.

### EXAMPLE 3

In this example, several ink compositions were prepared and tested using an HP Photosmart Pro B9180 printer. Some of the inks were prepared having embodiments of the solvent system disclosed herein. These inks were compared to the inks that came with the HP Photosmart Pro B9180 printer (the comparative inks are referred to herein as “Example 3 CTS”). Generally, the ink vehicle of the Example 3 CTS inks included various organic solvents (but not a betaine solvent), polymeric binders, and nonionic surfactants.

The ink vehicle formulas for the four inks having embodiments of the solvent system disclosed herein are shown in Tables 4-7 (below). Each of the four ink compositions also included pigment at loads that were the same as those used in the Example 3 CTS inks.

These four ink compositions were tested, and the performance of the ink vehicles was compared to the performance of the Example 3 CTS inks.

Table 4 provides the formula of Ink Vehicle A (as shown above in Table 1 of Example 1) having a betaine and glycerol solvent system, where the betaine solvent and the glycerol solvent are provided in equal concentrations.

TABLE 4
Ink Vehicle A - Including a Betaine/Glycerol Solvent System

| COMPONENT | CONCENTRATION, wt % |
|---|---|
| 2-pyrrolidone | 2.0 |
| Glycerol | 10.0 |
| Betaine | 10.0 |
| Polymeric Binder (Joncryl ® 683) | 2.0 |
| Polymeric Binder (SMA-1000Na) | 0.175 |
| Nonionic surfactant | 0.2 |
| Biocide | 0.1 |
| Diethylene glycol | 1.0–4.0 |

Table 5 provides an ink vehicle formulation having a betaine and 2-pyrrolidone solvent system.

TABLE 5
Ink Vehicle B - Including a Betaine/2-Pyrrolidone Solvent System

| COMPONENT | CONCENTRATION, wt % |
|---|---|
| 2-pyrrolidone | 12.0 |
| Glycerol | 10.0 |
| Betaine | 10.0 |
| Polymeric Binder (Joncryl ® 683) | 2.0 |
| Polymeric Binder (SMA-1000Na) | 0.175 |
| Nonionic surfactant | 0.2 |
| Biocide | 0.1 |
| Diethylene Glycol | 1.0–4.0 |

Table 6 provides an ink vehicle formulation in accordance with an embodiment of the present disclosure, where the light cyan ink formulation exhibited improved bronzing control by visual comparison with the light cyan Example 3 CTS (bronzing results shown below in Table 8).

TABLE 6
Ink Vehicle C

| COMPONENT | CONCENTRATION, wt % |
|---|---|
| 2-pyrrolidone | 2.0 |
| Glycerol | 10.0 |
| Betaine | 10.0 |
| Polymeric Binder (water-soluble | 2.0 |
| polyurethane) | |
| Nonionic surfactant | 0.2 |
| Biocide | 0.1 |
| Diethylene glycol | 1.0–4.0 |

Table 7 provides an ink vehicle formulation in accordance with an embodiment of the present disclosure. The light gray ink formulated with Ink Vehicle D exhibited improved glossiness when compared to the light cyan Example 3 CTS.

TABLE 7
Ink Vehicle D

| COMPONENT | CONCENTRATION, wt % |
|---|---|
| 2-pyrrolidone | 2.0 |
| Glycerol | 10.0 |
| Betaine | 10.0 |
| Polymeric Binder (Joncryl ® 683) | 2.0 |
| Polymeric Binder (SMA-1000Na) | 0.175 |
| 1,2-hexanediol | 4.0 |
| Fluorosurfactant | 0.2 |
| Triethanolamine | 0.8 |
| Non-ionic surfactant | 0.2 |
| Biocide | 0.1 |
| Diethylene glycol | 1.0–4.0 |

A comparison of the relative glossiness and the degree of bronzing is shown in Table 8 (below) for light cyan and light gray ink compositions A-D (the vehicles of which are provided in Tables 4-7 above) and the light cyan and light gray Example 3 CTS inks that came with the HP Photosmart Pro B9180 printer. The relative glossiness was measured with a BYK Gloss-meter operated at a 20 degree angle. Generally, gloss having a value below 20 is considered to be “low gloss” and is ranked herein as having a value of 1 on a scale of 1 to 3, gloss having a value between 20 and 40 is considered to be “medium gloss” and is ranked herein as having a value of 2, and gloss having a value above 40 is considered to be “high gloss” and is ranked herein as having a value of 3.

Bronzing was evaluated by visual comparison of the light cyan and light gray inks A-D with the light cyan and light gray Example 3 CTS inks. The reflection of fluorescent white light at a specular angle was observed, and the degree of bronzing was ranked from 1 to 3, where 1 designates severe bronzing (i.e., a very noticeable metallic luster appearance), 2 designates moderate bronzing (i.e., a moderately noticeable metallic luster appearance), and 3 designates no bronzing (i.e., no metallic luster appearance).

TABLE 8
Comparison of Glossiness and Bronzing between Ink
Vehicles A–D and Example 3 Comparative Test
Samples Including Light Cyan or Light Gray Pigment

| INK VEHICLE/COLOR | GLOSSINESS | BRONZING |
|---|---|---|
| Ink vehicle A/light cyan | 2 | 2 |
| Ink vehicle B/light cyan | 3 | 2 |
| Ink vehicle C/light cyan | 2 | 3 |
| Ink vehicle D/light cyan | 3 | 2 |
| Example 3 CTS/light cyan | 3 | 2 |
| Ink vehicle A/light gray | 3 | 2 |
| Ink vehicle B/light gray | 3 | 2 |
| Ink vehicle C/light gray | No Data | No Data |
| Ink vehicle D/light gray | 3 | 2 |
| Example 3 CTS/light gray | 3 | 1 |

The results indicate that most of the ink vehicles tested (e.g., Ink Vehicles A, B and D with light gray pigment and Ink Vehicles B and D with cyan pigment) exhibited desirably high glossiness values. Both light cyan and light gray ink vehicles exhibited moderate to no bronzing. These results are either similar to, or better than the comparative test inks, which exhibited moderate or severe bronzing.

Overall, the bronzing and gloss results shown in Table 8 indicate that inks formulated with the betaine solvent system and higher binder load disclosed herein are capable of achieving comparable gloss and bronzing to inks having different solvent systems and lower binder loads.

While several embodiments have been described in detail, it will be apparent to those skilled in the art that the disclosed embodiments may be modified. Therefore, the foregoing description is to be considered exemplary rather than limiting.

What is claimed is:

1. An ink composition, comprising:
a solvent system including an effective amount of a betaine solvent and an effective amount of 2-pyrrolidone, glycerol, or a combination thereof;
an effective amount of at least one surfactant;
an effective amount of at least one polymeric binder;
water; and
a pigment.

2. The ink composition as defined in claim 1 wherein the betaine solvent is represented by the formula (R₃)N⁺—CH₂—COO⁻, wherein R is CH₃.

3. The ink composition as defined in claim 1 wherein the solvent system is present in an amount ranging from about 10.0 to about 25.0 wt %.

4. The ink composition as defined in claim 1 wherein the betaine solvent is present in an amount ranging from about 5.0 to about 15.0 wt %.

5. The ink composition as defined in claim 1 wherein the 2-pyrrolidone, glycerol, or the combination thereof is present in an amount ranging from about 5.0 to about 15.0 wt %.

6. The ink composition as defined in claim 1 wherein the at least one polymeric binder is selected from styrene-acrylic copolymers, polyurethanes, styrene-maleic acid copolymers, and combinations thereof.

7. The ink composition as defined in claim 1 wherein the at least one polymeric binder is present in an amount ranging from about 2.0 to about 6.0 wt %.

8. The ink composition as defined in claim 1 wherein the pigment is present in an amount ranging from about 1.0 to about 5.0 wt %.

9. The ink composition as defined in claim 1, further comprising an effective amount of additives.

10. The ink composition as defined in claim 1 wherein the at least one surfactant is nonionic, anionic or a combination thereof.

11. The ink composition as defined in claim 10 wherein the at least one surfactant is present in an amount up to about 10.0 wt %.

12. A method of making an ink composition, comprising:
providing an ink vehicle including:
a solvent system present in an amount ranging from about 10.0 to about 20.0 wt %, wherein the solvent system includes a betaine solvent and glycerol, 2-pyrrolidone, or a combination thereof;
at least one surfactant present in an amount ranging from about 0.0 wt % to about 10.0 wt %;
at least one polymeric binder present in an amount ranging from about 2.0 to about 6.0 wt %; and
water; and
adding an effective amount of a pigment to the ink vehicle.

13. The method as defined in claim 12 wherein the betaine solvent is represented by the formula (R₃)N⁺—CH₂—COO⁻, wherein R is CH₃, and wherein the betaine solvent is present in an amount ranging from about 5.0 to about 15.0 wt %.

14. The method as defined in claim 12 wherein the glycerol, 2-pyrrolidone, or the combination thereof is present in an amount ranging from about 5.0 to about 15.0 wt %.

15. The method as defined in claim 12 wherein the at least one polymeric binder is selected from styrene-acrylic copolymers, polyurethanes, and combinations thereof.

16. The method as defined in claim 12 wherein the ink vehicle further comprises additives present in an amount up to about 0.2 wt %.

17. A method of forming an image on a substrate, comprising:
providing an ink composition including:
a solvent system present in an amount ranging from about 10.0 to about 25.0 wt %, wherein the solvent system includes a betaine solvent represented by the formula (R₃)N⁺—CH₂—COO⁻ and glycerol, 2-pyrrolidone, or a combination thereof, wherein R is CH₃;
at least one surfactant present in an amount ranging from about 0.0 to about 10.0 wt %;
at least one polymeric binder present in an amount ranging from about 2.0 to about 6.0 wt %;
water; and
a pigment; and
establishing the ink composition on at least a portion of the substrate.

18. The method as defined in claim 17 wherein establishing the ink on at least a portion of the substrate is accomplished by drop-on-demand inkjet printing, wherein the drop-on-demand inkjet printing is accomplished using a portable thermal inkjet printer, a desktop thermal inkjet printer, a portable piezoelectric inkjet printer, a desktop piezoelectric inkjet printer, or combinations thereof.

19. An ink composition, consisting essentially of:
a solvent system including an effective amount of a betaine solvent and an effective amount of glycerol, 2-pyrrolidone, or a combination thereof;
an effective amount of at least one surfactant;
an effective amount of at least one polymeric binder;
water; and
a pigment.
